(19) United States
(12) Patent Application Publication
(10) Pub. No.: US 2007/0157851 A1
(43) Pub. Date: Jul. 12, 2007

(54) Liquid clay

(75) Inventors: Kikue Hayashihara, Tokyo (JP); Kazunori Hayashihara, Tokyo (JP)

Correspondence Address: WILLIAM COLLARD;COLLARD & ROE, P.C., 1077 NORTHERN BOULEVARD, ROSLYN, NY, 11576, US

(73) Assignee: KITA-BOSHI PENCIL CO. LTD., Chuo-ku, Tokyo, JP (JP)

(21) Appl. No.: 10/596,127

(22) PCT Filed: Apr. 13, 2004
(86) PCT No.: PCT/JP04/05276

§ 371 Date: May 31, 2006

(51) Int. Cl. C08L 97/02

(52) U.S. Cl. 106/164.01; 106/164.44; 106/164.5

(57) ABSTRACT

An object of the invention is to provide a liquid clay allowing paintings to be freely made on a painting media such as a drawing board or cardboard with a spatula, and whereby the picture that has been painted presents a texture similar to that of an oil painting. This is characterized in that it is produced as a result of adding fine vegetable powder and sodium alginate or an equivalent material to an aqueous solution of CMC (carboxymethylcellulose) or an equivalent material and kneading, so as to prepare a liquid clay body in a state suitable for spatula application, and in that pigment is added to this liquid clay body.

### TECHNICAL FIELD

The present invention relates to liquid clay, which is not actually clay but rather a material having a viscosity similar to clay to which water has been added, and which is principally suited to painting.

Conventionally, clay has been provided to the market for clay molding, wherein desired objects such as vehicles, animals, plants, people, buildings, and implements are three-dimensionally represented using a material that has been kneaded to a softness suitable for working (for example, see Non-patent Reference 1).

(Non-Patent Reference 1)

Sekai Daihyakka Jiten (Large Encyclopedia of the World), vol. 22, Heibonsha Publishers Limited, first edition published on Apr. 28, 1988, from the 40^{th} line in the left column to the 26^{th} line in the middle column.

### PROBLEMS TO BE SOLVED BY THE INVENTION

However, it is not possible to paint a picture on a painting medium with a spatula using clay that was prepared for molding in the manner described above.

The present invention solves the aforementioned problem, and an object thereof is to provide a liquid clay allowing paintings to be freely made with a spatula on a painting media such as drawing boards or cardboard, and whereby the picture that has been painted presents a texture similar to that of an oil painting.

### DISCLOSURE OF THE INVENTION

In order to solve the problems described above, the invention recited in Claim 1 is characterized in that, a liquid clay body in a state suitable for spatula application is prepared by combining and kneading an aqueous solution of carboxymethylcellulose or an equivalent material, fine vegetable powder comprising vegetable matter including wood, and sodium alginate or an equivalent material, and by further adding any one pigment or a plurality of pigments, the color of the liquid clay body is modified, the liquid clay body serving as a clay-like paint having the aforementioned color.

Furthermore, in order to solve the problem described above, the invention recited in Claim 2 is characterized in that, by combining and kneading an aqueous solution of carboxymethylcellulose or an equivalent material, fine vegetable powder comprising vegetable matter including wood, sodium alginate or an equivalent material, and any one pigment or a plurality of pigments, a liquid clay body is prepared in a state suitable for spatula application, which has the aforementioned color, the liquid clay body serving as a clay-like paint.

Furthermore, in order to solve the problem described above, in the invention recited in Claim 3, the liquid clay recited in Claim 1 or 2 is characterized in that the liquid clay is prepared by combining and kneading carboxymethylcellulose, an aqueous solution of PVA adhesive, fine vegetable powder comprising vegetable matter including wood, sodium alginate or an equivalent material.

Furthermore, in order to solve the problem described above, in the invention recited in Claim 4, the liquid clay recited in Claim 3 is characterized in that titanium is further added to and kneaded with the liquid clay body.

In order to solve the problems described above, in the invention recited in Claim 5, the liquid clay recited in any of Claims 1 to 4 is characterized in that the fine vegetable powder is a fine powder containing wood sawdust.

Furthermore, in order to solve the problem described above, in the invention recited in Claim 6, the liquid clay recited in any of Claims 2 to 5 is characterized in that the sawdust contains at least any one from among, Japanese cedar, Japanese cypress, Thujopsis dolabrata, hemlock spruce, fir, Japanese black pine, Japanese red pine, spruce, white fir, Thuja standishii larch, umbrella pine, Japanese oak, beech, fraxinus griffithii, ash, zelkova tree, paulownia tree, cherry tree, chestnut tree, maple tree, Cercidiphyllum japonicum, camphor tree, cryptomeria, Oregon pine, yellow cedar, mertensiana, oak, mahogany, redwood, sequoia cedar, incense cedar, Tilia japonica, teak, Taiwan cypress, ebony, lauan tree, and Chaenomeles sinensis.

Furthermore, in order to solve the problem described above, in the invention recited in Claim 7, the liquid clay recited in any of Claims 2 to 6 is characterized in that the sawdust is formed into a block by applying pressure and then ground into a 50 to 150 fine powder.

Furthermore, in order to solve the problem described above, in the invention recited in Claim 8, the liquid clay characterized in that the liquid clay recited in any of Claims 1 to 7 is enclosed in containers for each of the colors of the liquid clay bodies.

### BRIEF DESCRIPTION OF THE DRAWINGS

FIG. 1 shows one example of preferred mixing ratios for starting materials for a clay body that is a seed material.

FIG. 2 shows one example of preferred mixing ratios for the seed material, water and pigments, which is an example of a liquid clay serving as a brown colored clay-like paint.

FIG. 3 shows one example of preferred mixing ratios for the seed material, water and pigments, which is an example of a liquid clay serving as a red colored clay-like paint.

FIG. 4 shows one example of preferred mixing ratios for the seed material, water and pigments, which is an example of a liquid clay serving as a black colored clay-like paint.

FIG. 5 shows one example of preferred mixing ratios for the seed material, water and pigments, which is an example of a liquid clay serving as a yellow colored clay-like paint.

FIG. 6 shows one example of preferred mixing ratios for the seed material, water and pigment, which is an example of a liquid clay serving as a white colored clay-like paint.

FIG. 7 shows one example of preferred mixing ratios for the seed material, water and pigment, which is an example of a liquid clay serving as a blue colored clay-like paint.

FIG. 8 shows one example of mixing ratios for each of the starting materials, which is an example of a liquid clay serving as a white colored clay-like paint having.

FIG. 9 shows one example of mixing ratios for each of the starting materials, which is an example of a liquid clay serving as a clay-like paint of various colors.

### BEST MODE FOR CARRYING OUT THE INVENTION

Hereinafter, modes of embodiment for the liquid clay according to the present invention is described.

The liquid clay represented by these modes of embodiment constitutes a material with which painting can be performed, which is prepared as a liquid clay body by combining and kneading an aqueous solution of carboxymethylcellulose or an equivalent material, finely powdered vegetable matter, and sodium alginate or an equivalent material, and adding a pigment to this liquid clay body so as to color it.

The carboxymethylcellulose is extracted from pulp in papermaking processes and is a component that bonds wood fibers; it is a highly safe food additive, which is used as a thickener for food products and in pharmaceutical products. The present invention uses this carboxymethylcellulose to affix the finely powdered vegetable matter to the painting medium, and therefore other materials can be used so long as they provide the same function and are safe in the manner described above.

Any fine vegetable powder may be used which is produced by finely grinding trees or herbage themselves, or fruits collected therefrom. However, in order that the liquid clay be provided to the market at the lowest possible price, waste products output by other industries may be used; if these waste products are fine powders, then it is suitable that they be sieved before use, and if these are in clumps, granules or the like, it is suitable that they be ground before use.

One preferred example of a fine vegetable powder is a fine powder containing wood sawdust. Use may also be made of a mixture of wood sawdust and another fine vegetable powder.

Representative sawdust is that containing at least one sawdust from among Japanese cedar, Japanese cypress, Thujopsis dolabrata, hemlock spruce, fir, Japanese black pine, Japanese red pine, spruce, white fir, Thuja standishii larch, umbrella pine, Japanese oak, beech, fraxinus griffithii, ash, zelkova tree, paulownia tree, cherry tree, chestnut tree, maple tree, Cercidiphyllum japonicum, camphor tree, cryptomeria, Oregon pine, yellow cedar, mertensiana, oak, mahogany, redwood, sequoia cedar, incense cedar, Tilia japonica, teak, Taiwan cypress, ebony, lauan tree, and Chaenomeles sinensis

Sawdust can be formed into blocks by applying pressure and then ground into a 50 to 150 fine powder. The particle size thereof may be approximately 80 to 100 mesh. However, if additional fine grinding is economically possible, it is preferable that a still finer powder be used. Mesh and micron units are such that 50 mesh equals 300 micron, 100 mesh equals 150 micron, and 200 mesh equals 75 micron (JIS Z8801).

Sodium alginate is a viscous polysaccharide extracted from seaweed, and is a highly safe food additive that is used as a thickener for food products and a thickening agent for dyes; it is characterized by not producing chemical reactions with any chemical dyes. Furthermore, in the present invention, it serves to render the texture of the applied liquid clay smooth. Accordingly, other materials can be used so long as these have the same function and have the safety described above.

In terms of the pigment, inorganic pigments that are insoluble in water, as well as organic solvents and finely powdered organic pigments are used, and the colors thereof that are used are the seven basic colors for colored paintings, which are white, red, blue, yellow, green, brown and black, and other pigments can be used as necessary.

In order to prepare liquid clay from the aforementioned materials, 64±1% of a 3% aqueous solution of carboxymethylcellulose and 25±6% of 100 mesh wood powder are placed in a kneader and kneaded for 10 minutes. Then, 10±5% of titanium oxide (blend differs according to color) and 1 to 2% of sodium alginate (improves smoothness) are added to this mixture and kneaded for 10 minutes to prepare a liquid clay body in a state that is suitable for spatula application.

When the liquid clay body has been prepared as described above, this liquid clay body is divided according to the number of colors required, for example into six parts in the case of the six colors: red, blue, yellow, green, brown and black. Then, 1% of red, blue, yellow, green and brown pigments are added to each of the divided liquid clay bodies, and these are kneaded for 10 minutes. Consequently, the pigments for each of the aforementioned colors are dispersed in the liquid clay bodies so as to uniformly color the liquid clay bodies and produce six colors of liquid clay in red, blue, yellow, green and brown.

Note that it is necessary to change the material blend only when preparing white liquid clay. Specifically, the amount of wood powder added to the 64% of the 3% aqueous solution of carboxymethylcellulose is reduced to 15% and the liquid clay body is prepared with 20% titanium oxide, which is a white pigment. Then, 1% of sodium alginate is added to this liquid clay body and kneaded so as to complete the liquid clay body. The completed liquid clay is a colored material having a viscosity similar to that of clay to which water has been added.

A container made from synthetic resin and formed with a large opening so as to facilitate removal with a spatula is filled with a predetermined quantity of the liquid clay that has been completed in the manner described above, and the opening is covered by a screw lid, which is provided with a seal member, so as to prevent evaporation of the water content during storage.

Next, when the seven colors of completed liquid clay are used, they may be used in the same manner as when painting pictures. Plywood, cardboard or the like, to which wood particles will adhere, is used for the painting medium and a picture is painted on this painting medium by taking up a single desired color of the liquid clay with a spatula, or by taking up a plurality of colors of the liquid clay with a spatula and using the spatula to mix them so as to produce the desired color, and applying these colors of liquid clay to the painting medium with the spatula.

The liquid clay in the picture that has been painted dries in a few hours, and the wood powder that is mixed therein forms a finish similar to that of oil paints on the drawing medium, so as to produce a heavy texture similar to that of an oil painting. In this condition, the painting can be stored indoors as it is, but outdoors the painting will be exposed to rain and the like, and therefore, so as to allow the painting to be installed outdoors, a gloss coating, such as an acrylic coating, is applied so as to coat the surface, so that the liquid clay is protected by this coating.

Hereinafter, examples of the present invention are described.

When manufacturing the liquid clay of the present invention, the clay body, which is the seed material for the liquid clay, is first prepared, after which the steps of adding water and pigment may be performed.

First, the carboxymethylcellulose or an equivalent material, the fine vegetable powder comprising vegetable matter including wood, and the sodium alginate or an equivalent material are combined and kneeded. In this manner, the clay body is prepared.

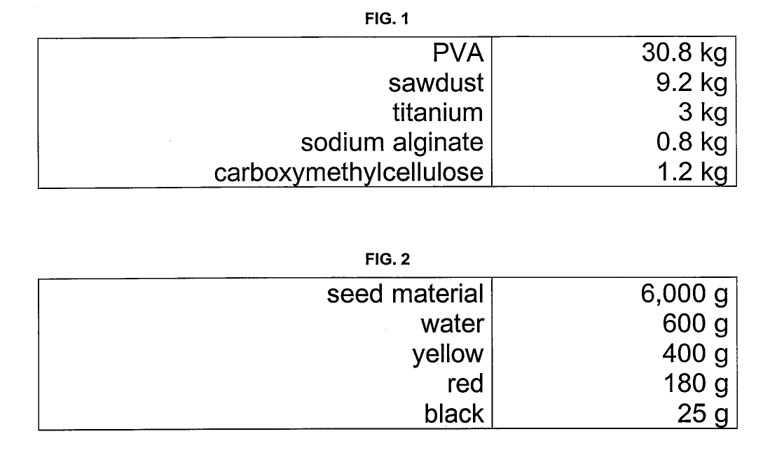

FIG. 1 shows one example of preferred mixing ratios for the starting materials for producing the clay body, which is the seed material.

Next, water and any one pigment or a plurality of pigments are added to produce a liquid clay body and modify the color thereof, so as to produce a liquid clay as a clay paint having the aforementioned color. The liquid clay can be enclosed in tube-type containers or other containers for each of the colors of the liquid clay bodies, and these may be used separately for each color.

Note that the liquid clay may also be prepared by combining and kneading the carboxymethylcellulose, an aqueous PVA adhesive solution, the fine vegetable powder comprising vegetable matter including wood, and the sodium alginate or an equivalent material, and then adding titanium to the liquid clay body and kneading.

FIG. 2 shows one example of preferred mixing ratios for the seed material, water and pigments, which is an example of a liquid clay serving as a brown colored clay-like paint.

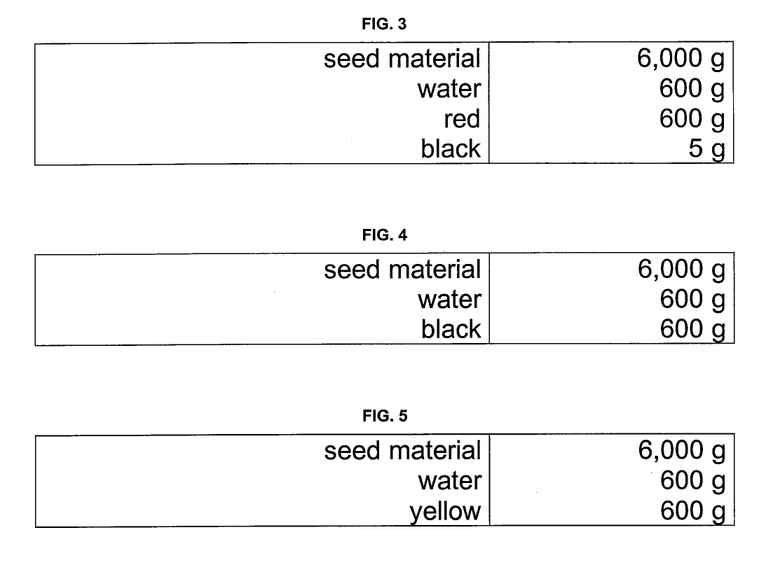

FIG. 3 shows one example of preferred mixing ratios for the seed material, water and pigments, which is an example of a liquid clay serving as a red colored clay-like paint.

FIG. 4 shows one example of preferred mixing ratios for the seed material, water and pigment, which is an example of a liquid clay serving as a black colored clay-like paint.

FIG. 5 shows one example of preferred mixing ratios for the seed material, water and pigment, which is an example of a liquid clay serving as a yellow colored clay-like paint.

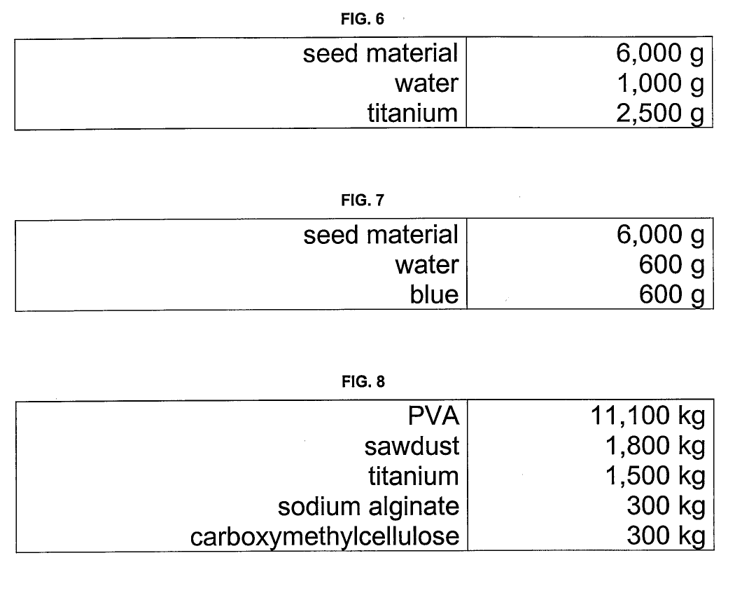

FIG. 6 shows one example of preferred mixing ratios for the seed material, water and pigment, which is an example of a liquid clay serving as a white colored clay-like paint.

FIG. 7 shows one example of preferred mixing ratios for the seed material, water and pigment, which is an example of a liquid clay serving as a blue colored clay-like paint.

The liquid clay of the present invention may be prepared by way of a process wherein, rather than first preparing a liquid clay body, which is the seed material for the liquid clay, the starting materials are all combined so as to prepare the liquid clay.

The liquid clay serving as a clay-like paint is produced by combining and kneading the aqueous solution of carboxymethylcellulose or an equivalent material, the fine vegetable powder comprising vegetable matter including wood, the sodium alginate or an equivalent material, and any one pigment or a plurality of pigments, so as to prepare a liquid clay body having the aforementioned color in a state that is suitable for spatula application. The liquid clay can be enclosed in tube-type containers or other containers for each of the colors of the liquid clay body, and these may be used separately for each color.

Note that the liquid clay may also be prepared by combining and kneading the carboxymethylcellulose, an aqueous PVA adhesive solution, the fine vegetable powder comprising vegetable matter including wood, and the sodium alginate or an equivalent material, and then adding titanium to the liquid clay body and kneading.

FIG. 8 shows one example of preferred mixing ratios for the starting materials described above, which is an example of a liquid clay serving as a white colored clay-like paint

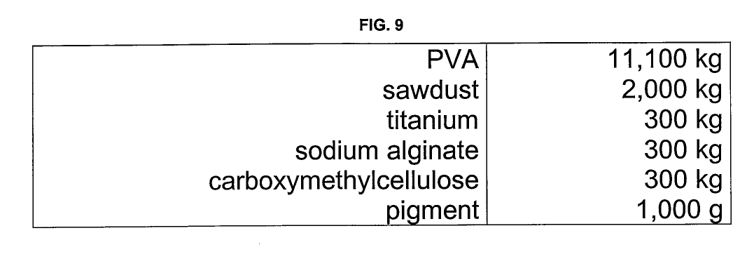

FIG. 9 shows one example of preferred mixing ratios for the starting materials described above, which is an example of a liquid clay serving as clay-like paint having various colors.

### INDUSTRIAL APPLICABILITY

As described in detail above, by virtue of the present invention, a liquid clay can be provided for freely painting pictures in desired colors, without soiling the hands, by mixing and applying with a spatula; furthermore, the picture that has been painted dries in a short time and has a heavy texture similar to that of oil paintings.

Furthermore, if the vegetable powder, which is a principal ingredient, is obtained from industrial waste, resources can be used efficiently and product costs can be reduced; in addition to which, because materials that have been approved as food additives are used for the adhesives and thickening agents, it is possible to provide a liquid clay which is sufficiently safe for infants, schoolchildren and the like.

1. Liquid clay wherein a clay body is prepared by combining and kneading carboxymethylcellulose or an equivalent material, fine vegetable powder comprising vegetable matter including wood, and sodium alginate or an equivalent material, and by further adding water and any one pigment or a plurality of pigments, a liquid clay body is produced and the color thereof is modified, the liquid clay body serving as a clay-like paint having said color.

2. Liquid clay wherein, by combining and kneading an aqueous solution of carboxymethylcellulose or an equivalent material, fine vegetable powder comprising vegetable matter including wood, sodium alginate or an equivalent material, and any one pigment or a plurality of pigments, a liquid clay body is prepared in a state suitable for spatula application and having said color, the liquid clay body serving as a clay-like paint.

3. The liquid clay recited in claim 1, wherein the liquid clay body is prepared by combining and kneading carboxymethylcellulose, an aqueous solution of PVA adhesive, fine vegetable powder comprising vegetable matter including wood, and sodium alginate or an equivalent material.

4. The liquid clay recited in claim 3 wherein titanium is further added to and kneaded with said liquid clay body.

5. The liquid clay recited in claim 1, wherein said fine vegetable powder is a fine powder containing wood sawdust.

6. The liquid clay recited in claim 2, wherein said sawdust contains at least any one from among Japanese cedar, Japanese cypress, Thujopsis dolabrata, hemlock spruce, fir, Japanese black pine, Japanese red pine, spruce, white fir, Thuja standishii larch, umbrella pine, Japanese oak, beech, fraxinus griffithii, ash, zelkova tree, paulownia tree, cherry tree, chestnut tree, maple tree, Cercidiphyllum japonicum, camphor tree, cryptomeria, Oregon pine, yellow cedar, mertensiana, oak, mahogany, redwood, sequoia cedar, incense cedar, Tilia japonica, teak, Taiwan cypress, ebony, lauan tree, and Chaenomeles sinensis.

7. The liquid clay recited in claim 2, wherein said sawdust is formed into a block by applying pressure and then ground into a 50 to 150 fine powder.

8. Liquid clay wherein the liquid clay recited in claim 1 is enclosed in containers for each of the colors of said liquid clay bodies.
